(19) United States
(12) Patent Application Publication
(10) Pub. No.: US 2025/0130819 A1
(43) Pub. Date: Apr. 24, 2025

(54) LAUNCHING CUSTOM AGENT EXTENSIONS USING EXTENSION WRAPPERS

(71) Applicant: Cisco Technology, Inc., San Jose, CA (US)

(72) Inventor: Walter Theodore Hulick, JR., Pearland, TX (US)

(21) Appl. No.: 18/394,003

(22) Filed: Dec. 22, 2023

Related U.S. Application Data
(60) Provisional application No. 63/545,317, filed on Oct. 23, 2023.

(51) Int. Cl. G06F 9/445

(52) U.S. Cl. CPC G06F 9/44526

(57) ABSTRACT

In one implementation, a method is disclosed comprising: associating an application with an agent that instruments the application during execution; configuring the agent to load an extension that alters functionality of the agent; configuring an implementation of the extension of the agent as a wrapper to launch one or more custom extensions; and executing the one or more custom extensions via the wrapper.

### RELATED APPLICATION

This application claims priority to U.S. Provisional Patent Appl. No. 63/545,317, filed on Oct. 23, 2023, entitled “LAUNCHING CUSTOM AGENT EXTENSIONS USING EXTENSION WRAPPERS” by Hulick, Jr., the contents of which are incorporated by reference herein.

### TECHNICAL FIELD

The present disclosure relates generally to computer systems, and, more particularly, to launching custom extensions by extension wrappers.

### BACKGROUND

The field of software development has witnessed a significant shift with the advent of cloud-native environments and microservices architecture. Traditional monolithic applications are giving way to more agile and scalable cloud-based microservices. One such element in this transformation has been the Open Telemetry Java Agent (herein referred to as the “OSS Java agent”).

The OSS Java agent plays a pivotal role in this evolving landscape, emerging as the de facto Java agent for cloud-native environments. The OSS Java agent provides a Java agent JAR that can be attached to any Java application and can dynamically inject bytecode to capture telemetry from a number of popular libraries and frameworks. Telemetry data may be exported in a variety of formats and the agent and exporter may be configured via command line arguments or environment variables. The net result is the ability to gather telemetry data from a Java application without code changes.

As organizations transition to microservices, the demand for customization and extensibility of the OSS Java agent has grown substantially. This transition has underscored the importance of incorporating value-added technology seamlessly into the OSS Java agent to meet the unique requirements of cloud-based applications.

To address the need for flexibility and extensibility, the Open Telemetry (OTEL) community introduced the concept of extensions. These extensions are designed to work in conjunction with the OSS Java agent, enhancing its functionality or introducing new features. They have the capability to modify or extend the behavior of the OSS Java agent and, in some cases, initiate the execution of additional agents during runtime.

These extensions, although promising, suffer from various shortcomings. For example, the current extension architecture suffers from impaired usability and efficiency resulting from shared class loaders, extension isolation, module duplication, limited dynamism, and a generally complex building process. In light of these challenges, there is a need for an improved architecture that streamlines the development, deployment, and management of extensions for the OSS Java agent, facilitating the creation of cloud-native applications with enhanced flexibility, modularity, and efficiency.

### BRIEF DESCRIPTION OF THE DRAWINGS

The implementations herein may be better understood by referring to the following description in conjunction with the accompanying drawings in which like reference numerals indicate identically or functionally similar elements, of which:

FIG. 1 illustrates an example computer network;

FIG. 2 illustrates an example computing device/node;

FIG. 3 illustrates an example observability intelligence platform;

FIGS. 4A-4B illustrate examples of generic extension interface definitions;

FIGS. 5A-5C illustrate examples of elements of an OSS Java agent extension architecture;

FIG. 6 illustrates an example of OSS Java agent extension utilization;

FIG. 7 Illustrates an example of a toolkit for building and deploying agent extensions into an agent;

FIGS. 8A-8B illustrate examples of agent modified jars for the toolkit building and deployment options for agent extensions;

FIGS. 9A-9D illustrate an example of extension wrapper execution while running the Java agent Jar;

FIG. 10 illustrates an example of sample AgentListener properties; and

FIG. 11 illustrates an example simplified procedure for launching custom extension by extension wrappers.

### DESCRIPTION OF EXAMPLE EMBODIMENTS

### Overview

According to one or more implementations of the disclosure, a method is introduced herein that facilitates launching custom extensions (e.g., introducing custom capabilities outside of the OSS Java agent lifecycle and control) via extension wrappers. The method may include configuring an agent that instruments an application during execution to load an extension that alters functionality of the agent. An implementation of the extension may be configured to operate as a wrapper that launches one or more custom extensions which may be executed via the wrapper.

Other implementations are described below, and this overview is not meant to limit the scope of the present disclosure.

### DESCRIPTION

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, and others. The Internet is an example of a WAN that connects disparate networks throughout the world, providing global communication between nodes on various networks. Other types of networks, such as field area networks (FANs), neighborhood area networks (NANs), personal area networks (PANs), enterprise networks, etc. may also make up the components of any given computer network. In addition, a Mobile Ad-Hoc Network (MANET) is a kind of wireless ad-hoc network, which is generally considered a self-configuring network of mobile routers (and associated hosts) connected by wireless links, the union of which forms an arbitrary topology.

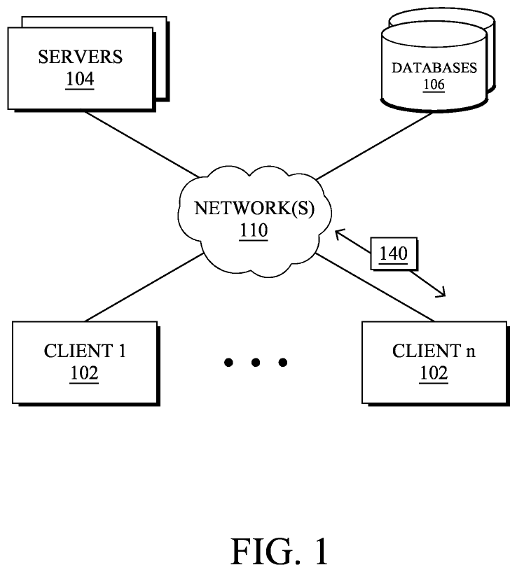

FIG. 1 is a schematic block diagram of an example simplified computing system 100 illustratively comprising any number of the client devices 102 (e.g., a first through nth client device), one or more of servers 104, and one or more of databases 106, where the devices may be in communication with one another via any number of networks (e.g., networks 110). The one or more networks (e.g., networks 110) may include, as would be appreciated, any number of specialized networking devices such as routers, switches, access points, etc., interconnected via wired and/or wireless connections. For example, devices 102-104 and/or the intermediary devices in network(s) (e.g., networks 110) may communicate wirelessly via links based on WiFi, cellular, infrared, radio, near-field communication, satellite, or the like. Other such connections may use hardwired links, e.g., Ethernet, fiber optic, etc. The nodes/devices typically communicate over the network by exchanging discrete frames or packets of data (packets 140) according to predefined protocols, such as the Transmission Control Protocol/Internet Protocol (TCP/IP) other suitable data structures, protocols, and/or signals. In this context, a protocol consists of a set of rules defining how the nodes interact with each other.

Client devices 102 may include any number of user devices or end point devices configured to interface with the techniques herein. For example, client devices 102 may include, but are not limited to, desktop computers, laptop computers, tablet devices, smart phones, wearable devices (e.g., heads up devices, smart watches, etc.), set-top devices, smart televisions, Internet of Things (IoT) devices, autonomous devices, or any other form of computing device capable of participating with other devices via network(s) (e.g., networks 110).

Notably, in some implementations, servers 104 and/or databases 106, including any number of other suitable devices (e.g., firewalls, gateways, and so on) may be part of a cloud-based service. In such cases, the servers and/or databases 106 may represent the cloud-based device(s) that provide certain services described herein, and may be distributed, localized (e.g., on the premise of an enterprise, or “on prem”), or any combination of suitable configurations, as will be understood in the art.

Those skilled in the art will also understand that any number of nodes, devices, links, etc. may be used in simplified computing system 100, and that the view shown herein is for simplicity. Also, those skilled in the art will further understand that while the network is shown in a certain orientation, the simplified computing system 100 is merely an example illustration that is not meant to limit the disclosure.

Notably, web services can be used to provide communications between electronic and/or computing devices over a network, such as the Internet. A web site is an example of a type of web service. A web site is typically a set of related web pages that can be served from a web domain. A web site can be hosted on a web server. A publicly accessible web site can generally be accessed via a network, such as the Internet. The publicly accessible collection of web sites is generally referred to as the World Wide Web (WWW).

Also, cloud computing generally refers to the use of computing resources (e.g., hardware and software) that are delivered as a service over a network (e.g., typically, the Internet). Cloud computing includes using remote services to provide a user's data, software, and computation.

Moreover, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a Software as a Service (SaaS) over a network, such as the Internet.

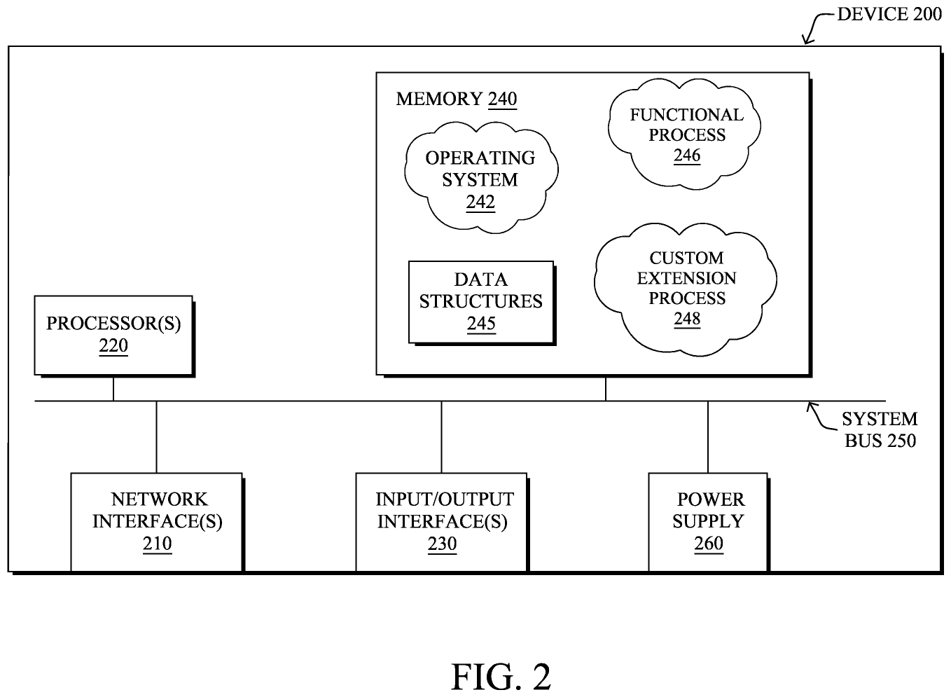

FIG. 2 is a schematic block diagram of an example node/device 200 that may be utilized with one or more implementations described herein, e.g., as any of the devices 102-106 shown in FIG. 1 described above as well as the present disclosure described below. Device 200 may comprise one or more network interfaces (e.g., network interfaces 210) (e.g., wired, wireless, etc.), at least one processor (e.g., processor 220), and a memory 240 interconnected by a system bus 250, as well as a power supply 260 (e.g., battery, plug-in, etc.).

The network interface(s) (e.g., network interfaces 210) contain the mechanical, electrical, and signaling circuitry for communicating data over links coupled to the network(s) (e.g., networks 110). The network interfaces may be configured to transmit and/or receive data using a variety of different communication protocols. Note, further, that device 200 may have multiple types of network connections via network interfaces 210, e.g., wireless and wired/physical connections, and that the view herein is merely for illustration.

Depending on the type of device, other interfaces, such as input/output (I/O) interfaces 230, user interfaces (UIs), and so on, may also be present on the device. Input devices, in particular, may include an alpha-numeric keypad (e.g., a keyboard) for inputting alpha-numeric and other information, a pointing device (e.g., a mouse, a trackball, stylus, or cursor direction keys), a touchscreen, a microphone, a camera, and so on. Additionally, output devices may include speakers, printers, particular network interfaces, monitors, etc.

The memory 240 comprises a plurality of storage locations that are addressable by the processor 220 and the network interfaces 210 for storing software programs and data structures associated with the implementations described herein. The processor 220 may comprise hardware elements or hardware logic adapted to execute the software programs and manipulate the data structures 245. An operating system 242, portions of which are typically resident in memory 240 and executed by the processor, functionally organizes the device by, among other things, invoking operations in support of software processes and/or services executing on the device. These software processes and/or services may comprise one or more of functional processes 246, and on certain devices, a custom extension process 248, as described herein. Notably, functional processes 246, when executed by processor(s) (e.g., processor 220), cause each particular device (e.g., device 200) to perform the various functions corresponding to the particular device's purpose and general configuration. For example, a router would be configured to operate as a router, a server would be configured to operate as a server, an access point (or gateway) would be configured to operate as an access point (or gateway), a client device would be configured to operate as a client device, and so on.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while the processes have been shown separately, those skilled in the art will appreciate that processes may be routines or modules within other processes.

### --Observability Intelligence Platform--

Distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a software as a service (SaaS) over a network, such as the Internet. As an example, a distributed application can be implemented as a SaaS-based web service available via a web site that can be accessed via the Internet. As another example, a distributed application can be implemented using a cloud provider to deliver a cloud-based service.

Users typically access cloud-based/web-based services (e.g., distributed applications accessible via the Internet) through a web browser, a light-weight desktop, and/or a mobile application (e.g., mobile app) while the enterprise software and user's data are typically stored on servers at a remote location. For example, using cloud-based/web-based services can allow enterprises to get their applications up and running faster, with improved manageability and less maintenance, and can enable enterprise IT to more rapidly adjust resources to meet fluctuating and unpredictable business demand. Thus, using cloud-based/web-based services can allow a business to reduce Information Technology (IT) operational costs by outsourcing hardware and software maintenance and support to the cloud provider.

However, a significant drawback of cloud-based/web-based services (e.g., distributed applications and SaaS-based solutions available as web services via web sites and/or using other cloud-based implementations of distributed applications) is that troubleshooting performance problems can be very challenging and time consuming. For example, determining whether performance problems are the result of the cloud-based/web-based service provider, the customer's own internal IT network (e.g., the customer's enterprise IT network), a user's client device, and/or intermediate network providers between the user's client device/internal IT network and the cloud-based/web-based service provider of a distributed application and/or web site (e.g., in the Internet) can present significant technical challenges for detection of such networking related performance problems and determining the locations and/or root causes of such networking related performance problems. Additionally, determining whether performance problems are caused by the network or an application itself, or portions of an application, or particular services associated with an application, and so on, further complicate the troubleshooting efforts.

Certain aspects of one or more implementations herein may thus be based on (or otherwise relate to or utilize) an observability intelligence platform for network and/or application performance management. For instance, solutions are available that allow customers to monitor networks and applications, whether the customers control such networks and applications, or merely use them, where visibility into such resources may generally be based on a suite of “agents” or pieces of software that are installed in different locations in different networks (e.g., around the world).

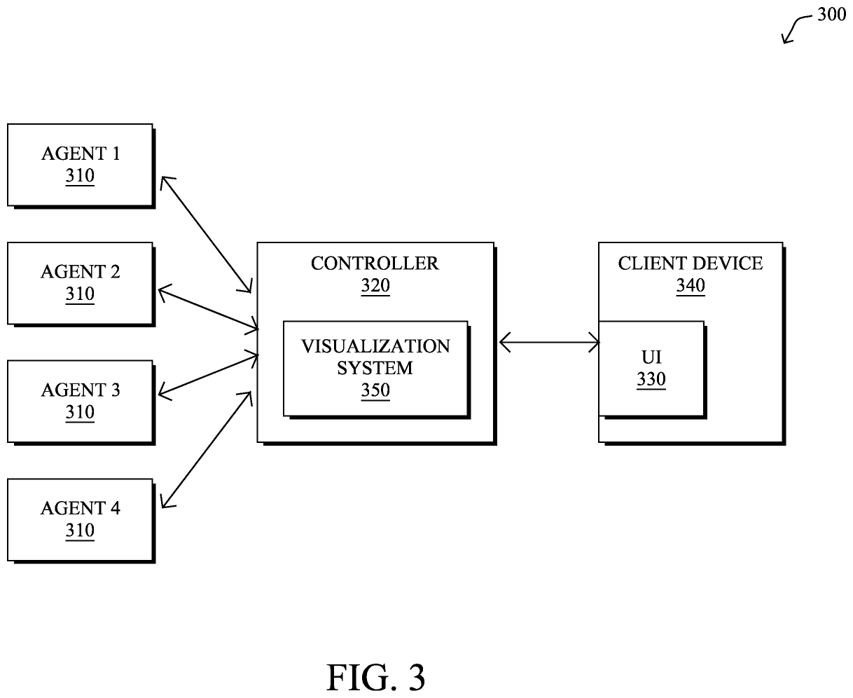

Specifically, as discussed with respect to illustrative FIG. 3 below, performance within any networking environment may be monitored, specifically by monitoring applications and entities (e.g., transactions, tiers, nodes, and machines) in the networking environment using agents installed at individual machines at the entities. As an example, applications may be configured to run on one or more machines (e.g., a customer will typically run one or more nodes on a machine, where an application consists of one or more tiers, and a tier consists of one or more nodes). The agents collect data associated with the applications of interest and associated nodes and machines where the applications are being operated. Examples of the collected data may include performance data (e.g., metrics, metadata, etc.) and topology data (e.g., indicating relationship information), among other configured information. The agent-collected data may then be provided to one or more servers or controllers to analyze the data.

Examples of different agents (in terms of location) may comprise cloud agents (e.g., deployed and maintained by the observability intelligence platform provider), enterprise agents (e.g., installed and operated in a customer's network), and endpoint agents, which may be a different version of the previous agents that is installed on actual users' (e.g., employees') devices (e.g., on their web browsers or otherwise). Other agents may specifically be based on categorical configurations of different agent operations, such as language agents (e.g., Java agents, .Net agents, PHP agents, and others), machine agents (e.g., infrastructure agents residing on the host and collecting information regarding the machine which implements the host such as processor usage, memory usage, and other hardware information), and network agents (e.g., to capture network information, such as data collected from a socket, etc.).

Each of the agents may then instrument (e.g., passively monitor activities) and/or run tests (e.g., actively create events to monitor) from their respective devices, allowing a customer to customize from a suite of tests against different networks and applications or any resource that they're interested in having visibility into, whether it's visibility into that end point resource or anything in between, e.g., how a device is specifically connected through a network to an end resource (e.g., full visibility at various layers), how a website is loading, how an application is performing, how a particular business transaction (or a particular type of business transaction) is being effected, and so on, whether for individual devices, a category of devices (e.g., type, location, capabilities, etc.), or any other suitable implementation of categorical classification.

FIG. 3 is a block diagram of an example observability intelligence platform 300 that can implement one or more aspects of the techniques herein. The observability intelligence platform is a system that monitors and collects metrics of performance data for a network and/or application environment being monitored. At the simplest structure, the observability intelligence platform includes one or more of agents 310 and one or more servers/controllers (e.g., controller 320). Agents may be installed on network browsers, devices, servers, etc., and may be executed to monitor the associated device and/or application, the operating system of a client, and any other application, API, or another component of the associated device and/or application, and to communicate with (e.g., report data and/or metrics to) the controller(s) (e.g., controller 320) as directed. Note that while FIG. 3 shows four agents (e.g., Agent 1 through Agent 4) communicatively linked to a single controller, the total number of agents and controllers can vary based on a number of factors including the number of networks and/or applications monitored, how distributed the network and/or application environment is, the level of monitoring desired, the type of monitoring desired, the level of user experience desired, and so on.

For example, instrumenting an application with agents may allow a controller to monitor performance of the application to determine such things as device metrics (e.g., type, configuration, resource utilization, etc.), network browser navigation timing metrics, browser cookies, application calls and associated pathways and delays, other aspects of code execution, etc. Moreover, if a customer uses agents to run tests, probe packets may be configured to be sent from agents to travel through the Internet, go through many different networks, and so on, such that the monitoring solution gathers all of the associated data (e.g., from returned packets, responses, and so on, or, particularly, a lack thereof). Illustratively, different “active” tests may comprise HTTP tests (e.g., using curl to connect to a server and load the main document served at the target), Page Load tests (e.g., using a browser to load a full page—i.e., the main document along with all other components that are included in the page), or Transaction tests (e.g., same as a Page Load, but also performing multiple tasks/steps within the page—e.g., load a shopping website, log in, search for an item, add it to the shopping cart, etc.).

The controller 320 is the central processing and administration server for the observability intelligence platform. The controller 320 may serve a browser-based user interface (UI) (e.g., interface 330) that is the primary interface for monitoring, analyzing, and troubleshooting the monitored environment. Specifically, the controller 320 can receive data from agents 310 (and/or other coordinator devices), associate portions of data (e.g., topology, business transaction end-to-end paths and/or metrics, etc.), communicate with agents to configure collection of the data (e.g., the instrumentation/tests to execute), and provide performance data and reporting through the interface 330. The interface 330 may be viewed as a web-based interface viewable by a client device 340. In some implementations, a client device 340 can directly communicate with controller 320 to view an interface for monitoring data. The controller 320 can include a visualization system 350 for displaying the reports and dashboards related to the disclosed technology. In some implementations, the visualization system 350 can be implemented in a separate machine (e.g., a server) different from the one hosting the controller 320.

Notably, in an illustrative Software as a Service (SaaS) implementation, a controller instance (e.g., controller 320) may be hosted remotely by a provider of the observability intelligence platform 300. In an illustrative on-premises (On-Prem) implementation, a controller instance (e.g., controller 320) may be installed locally and self-administered.

Controllers 320 receive data from different agents (e.g., Agents 1-4) deployed to monitor networks, applications, databases and database servers, servers, and end user clients for the monitored environment. Any of the agents 310 can be implemented as different types of agents with specific monitoring duties. For example, application agents may be installed on each server that hosts applications to be monitored. Instrumenting an agent adds an application agent into the runtime process of the application.

Database agents, for example, may be software (e.g., a Java program) installed on a machine that has network access to the monitored databases and the controller. Standalone machine agents, on the other hand, may be standalone programs (e.g., standalone Java programs) that collect hardware-related performance statistics from the servers (or other suitable devices) in the monitored environment. The standalone machine agents can be deployed on machines that host application servers, database servers, messaging servers, Web servers, etc. Furthermore, end user monitoring (EUM) may be performed using browser agents and mobile agents to provide performance information from the point of view of the client, such as a web browser or a mobile native application. Through EUM, web use, mobile use, or combinations thereof (e.g., by real users or synthetic agents) can be monitored based on the monitoring needs.

Note that monitoring through browser agents and mobile agents are generally unlike monitoring through application agents, database agents, and standalone machine agents that are on the server. In particular, browser agents may generally be embodied as small files using web-based technologies, such as JavaScript agents injected into each instrumented web page (e.g., as close to the top as possible) as the web page is served, and are configured to collect data. Once the web page has completed loading, the collected data may be bundled into a beacon and sent to an EUM process/cloud for processing and made ready for retrieval by the controller. Browser real user monitoring (Browser RUM) provides insights into the performance of a web application from the point of view of a real or synthetic end user. For example, Browser RUM can determine how specific Ajax or iframe calls are slowing down page load time and how server performance impact end user experience in aggregate or in individual cases. A mobile agent, on the other hand, may be a small piece of highly performant code that gets added to the source of the mobile application. Mobile RUM provides information on the native mobile application (e.g., iOS or Android applications) as the end users actually use the mobile application. Mobile RUM provides visibility into the functioning of the mobile application itself and the mobile application's interaction with the network used and any server-side applications with which the mobile application communicates.

Note further that in certain implementations, in the application intelligence model, a business transaction represents a particular service provided by the monitored environment. For example, in an e-commerce application, particular real-world services can include a user logging in, searching for items, or adding items to the cart. In a content portal, particular real-world services can include user requests for content such as sports, business, or entertainment news. In a stock trading application, particular real-world services can include operations such as receiving a stock quote, buying, or selling stocks.

A business transaction, in particular, is a representation of the particular service provided by the monitored environment that provides a view on performance data in the context of the various tiers that participate in processing a particular request. That is, a business transaction, which may be identified by a unique business transaction identification (ID), represents the end-to-end processing path used to fulfill a service request in the monitored environment (e.g., adding items to a shopping cart, storing information in a database, purchasing an item online, etc.). Thus, a business transaction is a type of user-initiated action in the monitored environment defined by an entry point and a processing path across application servers, databases, and potentially many other infrastructure components. Each instance of a business transaction is an execution of that transaction in response to a particular user request (e.g., a socket call, illustratively associated with the TCP layer). A business transaction can be created by detecting incoming requests at an entry point and tracking the activity associated with request at the originating tier and across distributed components in the application environment (e.g., associating the business transaction with a 4-tuple of a source IP address, source port, destination IP address, and destination port). A flow map can be generated for a business transaction that shows the touch points for the business transaction in the application environment. In one implementation, a specific tag may be added to packets by application specific agents for identifying business transactions (e.g., a custom header field attached to a hypertext transfer protocol (HTTP) payload by an application agent, or by a network agent when an application makes a remote socket call), such that packets can be examined by network agents to identify the business transaction identifier (ID) (e.g., a Globally Unique Identifier (GUID) or Universally Unique Identifier (UUID)). Performance monitoring can be oriented by business transaction to focus on the performance of the services in the application environment from the perspective of end users. Performance monitoring based on business transactions can provide information on whether a service is available (e.g., users can log in, check out, or view their data), response times for users, and the cause of problems when the problems occur.

In accordance with certain implementations, the observability intelligence platform may use both self-learned baselines and configurable thresholds to help identify network and/or application issues. A complex distributed application, for example, has a large number of performance metrics and each metric is important in one or more contexts. In such environments, it is difficult to determine the values or ranges that are normal for a particular metric; set meaningful thresholds on which to base and receive relevant alerts; and determine what is a “normal” metric when the application or infrastructure undergoes change. For these reasons, the disclosed observability intelligence platform can perform anomaly detection based on dynamic baselines or thresholds, such as through various machine learning techniques, as may be appreciated by those skilled in the art. For example, the illustrative observability intelligence platform herein may automatically calculate dynamic baselines for the monitored metrics, defining what is “normal” for each metric based on actual usage. The observability intelligence platform may then use these baselines to identify subsequent metrics whose values fall out of this normal range.

In general, data/metrics collected relate to the topology and/or overall performance of the network and/or application (or business transaction) or associated infrastructure, such as, e.g., load, average response time, error rate, percentage CPU busy, percentage of memory used, etc. The controller UI can thus be used to view all of the data/metrics that the agents report to the controller, as topologies, heatmaps, graphs, lists, and so on. Illustratively, data/metrics can be accessed programmatically using a Representational State Transfer (REST) API (e.g., that returns either the JavaScript Object Notation (JSON) or the extensible Markup Language (XML) format). Also, the REST API can be used to query and manipulate the overall observability environment.

Those skilled in the art will appreciate that other configurations of observability intelligence may be used in accordance with certain aspects of the techniques herein, and that other types of agents, instrumentations, tests, controllers, and so on may be used to collect data and/or metrics of the network(s) and/or application(s) herein. Also, while the description illustrates certain configurations, communication links, network devices, and so on, it is expressly contemplated that various processes may be embodied across multiple devices, on different devices, utilizing additional devices, and so on, and the views shown herein are merely simplified examples that are not meant to be limiting to the scope of the present disclosure.

### --Launching Custom Extensions by Extension Wrappers--

As noted above, the current extension architecture suffers from a variety of performance degrading shortcomings that ultimately render it inadequate to introduce meaningful custom functionality (e.g., extend OpenTelemetry functionality) from outside of the OSS Java agent lifecycle and control. For instance, all extensions are loaded in the same class loader in the current paradigm. This means that conflicts among libraries are commonplace. Further, currently each extension must be built separately and if extension interfaces are changed (which frequently occurs) all of the extensions are impacted.

Moreover, the entire functionality of each extension must be within that extension. As a result, there is no ability to share common modules and duplicate modules with the same code are commonplace. Therefore, the person writing the extension is forced to deal with the complexity of extensions. In addition, under the current extension architecture, extensions cannot be loaded and unloaded dynamically, instead a complete reboot of the application is required to upgrade an extension. In general, the overall build process/script is overly complicated and inefficient.

In contrast, the techniques herein describe mechanisms that facilitate launching of custom extensions by extension wrappers. By utilizing extensions that operate as wrappers to launch custom extensions, these techniques provide mechanisms that greatly reduce the time, complexity, total cost of ownership required to write an extension for an agent. The extensions operating as wrappers do not actually provide the implementations themselves, but rather they operate as wrappers around an invocation method which handles the implementation. This architecture allows for a flexible and re-usable model to launch and extend the agent functionality without having to rewrite or re-architect the extension launch mechanism-thus greatly simplifying and accelerating the development process.

Illustratively, the techniques described herein may be performed by hardware, software, and/or firmware, such as in accordance with custom extension process 248, which may include computer executable instructions executed by the processor 220 (or independent processor of network interfaces 210) to perform functions relating to the techniques described herein.

Specifically, according to various implementations, a method may include associating, by a device, an application with an agent that instruments the application during execution (e.g., to generate OpenTelemetry data); configuring, by the device, the agent to load an extension that alters functionality of the agent; configuring, by the device, an implementation of the extension of the agent as a wrapper to launch one or more custom extensions; and/or executing, by the device, the one or more custom extensions via the wrapper.

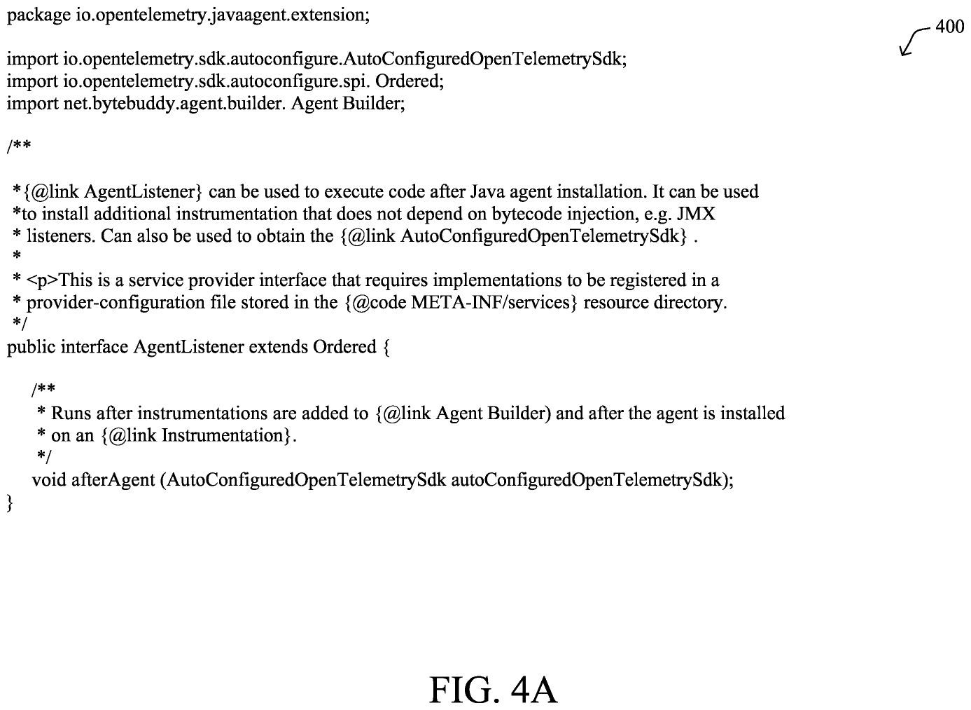

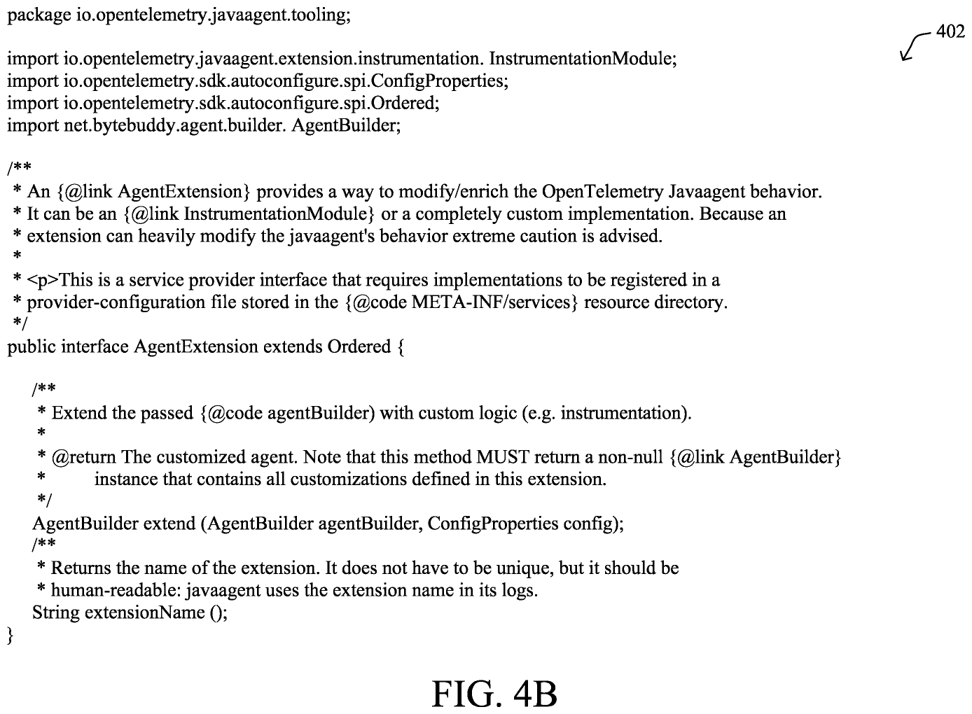

Operationally and according to various implementations, FIGS. 4A-4B illustrate examples of generic extension interface definitions that may be utilized for launching custom extensions by extension wrappers, in accordance with one or more implementations described herein. The Open Telemetry Java Agent (herein referred to as “OSS Java agent”) may be an opensource software (OSS) java agent that may be developed within the OpenTelemetry community. Such a java agent may be configured to auto instrument applications with OpenTelemetry SDK/API calls.

Although OpenTelemetry was designed for application developers and third-party library developers to write directly to the SDK/API, its adoption has not occurred as rapidly as the community had hoped. The OSS Java agent described herein was consequently developed to bridge that gap and speed its adoption. This Java agent is emerging as the “de facto” Java agent for the cloud native environment as companies shift away from large monolithic hosted applications to cloud based microservices. As a result, this is placing a tremendous emphasis on being able to develop and build value added technology into and around the OSS Java agent.

Thus far, the method and interface for “extending” the OSS Java agent is via “extensions.” Essentially, extensions are a way of adding functionality on top of the agent in the form of classes that implement or extend standard interfaces. These classes are generally either packaged into JARs and loaded into the agent via a specific property (e.g., -Dotel.javaagent.extensions=folder1, etc.) or they are embedded into the OSS Java agent JAR file in the form of services to be loaded by a service loader using provider files and classes. These may be obfuscated such that the OSS Java agent can distinguish where the classes should be loaded. In some instances, embedding the classes into the OSS Java agent JAR file is a preferred method as this results in a single self-contained JAR.

However, the techniques described herein expand this architecture by utilizing, among other elements, generic extension wrappers which are generic extensions that operate as wrappers. These generic extensions may include extensions which are configured with the ability to launch functionality that is not necessarily tied to a specific OpenTelemetry interface. Rather, the generic extensions are configured with the ability to launch generic modules which extend or complement the value of the agent itself.

The OSS Java agent may be configured with the ability to support multiple of these types of generic extensions. FIGS. 4A-4B illustrate two example extension types (e.g., AgentListener and AgentExtension). These, or other generic extension types, may be utilized to launch generic modules as they are capable of launching an agent at the OSS Java agent bootstrap time; however, implementations are not so limited. Additionally, or alternatively, other generic extensions may be used to launch the generic modules.

FIG. 4A illustrates a generic interface definition for an AgentListener type 400 of generic extension. An implementation of the AgentListener may be built and/or injected into the OSS Java agent. The implementation of the AgentListener may be configured to launch extended functionality (e.g., via custom extensions) of the OSS Java agent when a particular method is called. For instance, the extended functionality may be launched when an afterAgent method is called as outlined in the generic interface definition for the AgentListener type 400.

FIG. 4B illustrates a generic interface definition for an AgentExtension type 402 of generic extensions. An implementation of the AgentExtension may be built and/or injected into the OSS Java agent. The implementation of the AgentExtension may be configured to launch extended functionality (e.g., via custom extensions) of the OSS Java agent when a particular method is called. For instance, the extended functionality may be launched when an extend method is called as outlined in the generic interface definition for the AgentExtension type 402.

Both the AgentListener afterAgent method and the AgentExtension extend method may be called during the OSS Java agent bootstrap phase. In fact, the OSS Java agent premain startup phase may still be active and invoke, for example, the ByteBuddy ServiceLoader to load classes into the agent class loader. This can be a beneficial location to launch additional extensions that focus on extending the agent beyond just span processing, custom sampling, etc. In addition, this can facilitate the ability to launch major functional expansions of the OSS Java agent through additional subagents, etc.

These extensions may be configured to operate as extension wrappers. As such, the extensions do not actually provide the implementations themselves. Rather, the extensions are configured to operate as wrappers around an invocation method which handles the implementation. The actual configuration for the invocation may instead be derived from a properties file which informs the extension what class/method to invoke and which files in the OSS Java agent are related to the implementation. This architecture facilitates a flexible and re-usable model configured to launch and extend the OSS Java agent functionality without having to rewrite or re-architect the extension launch mechanism. Thus, the development process for functional expansion of agents such as OSS Java agent may be greatly simplified and accelerated.

Being configured to operate as a wrapper may mean that the extensions operate as a gateway of sorts into launching modules inside the OSS Java agent. The actual modules to which the wrappers provide the gateway provide the extended functionality being introduced. These modules may include custom logic and/or custom extensions that can be sub-agents that provide functionality independent of the OSS Java agent's core code and/or functions. For example, the generic extensions may be configured as extension wrappers that facilitate the launching of a Multi-Tenant agent and/or a Secure Application product which runs as a tenant under the OSS Java agent.

Using these generic extension wrappers, the custom logic and/or extensions can be packaged with the OSS Java agent at a customer site and/or downloaded from a portal. Essentially, this architecture may facilitate coupling and launching of custom extensions into the OSS Java agent.

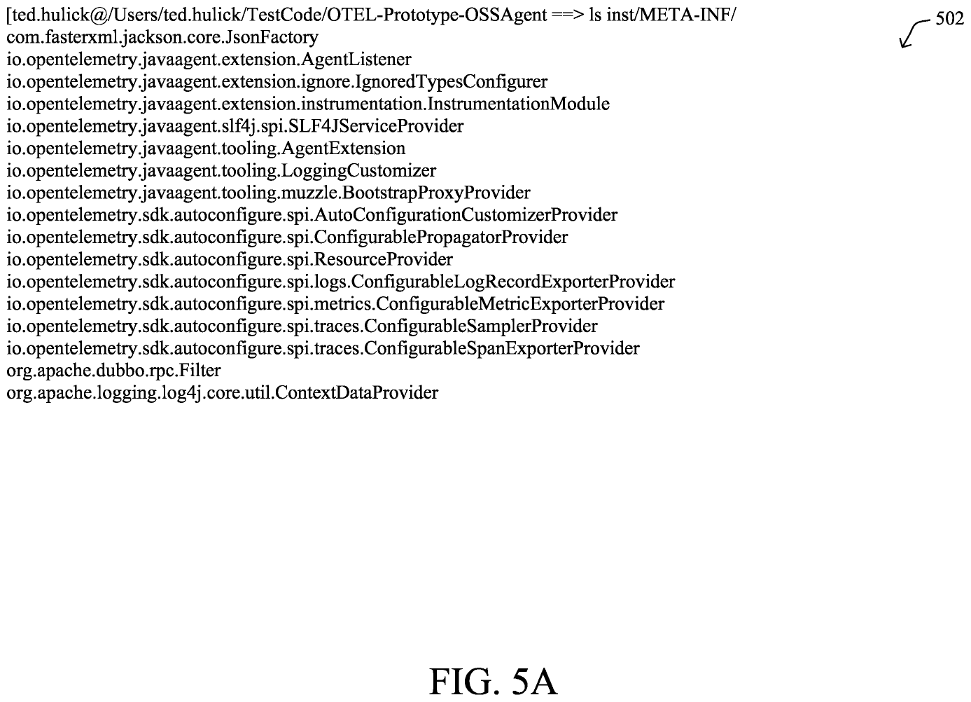

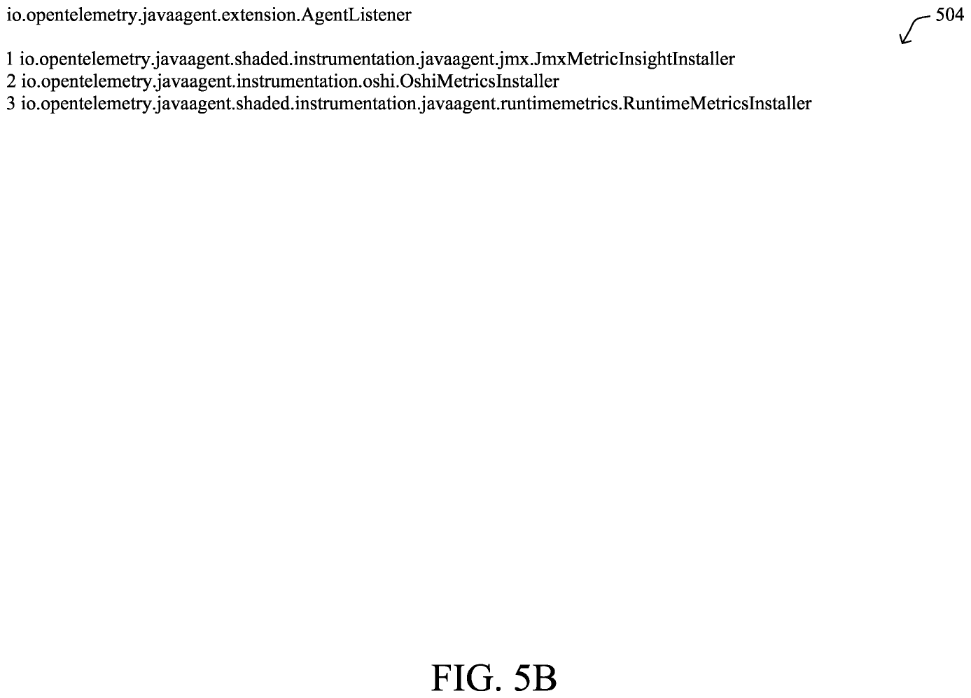

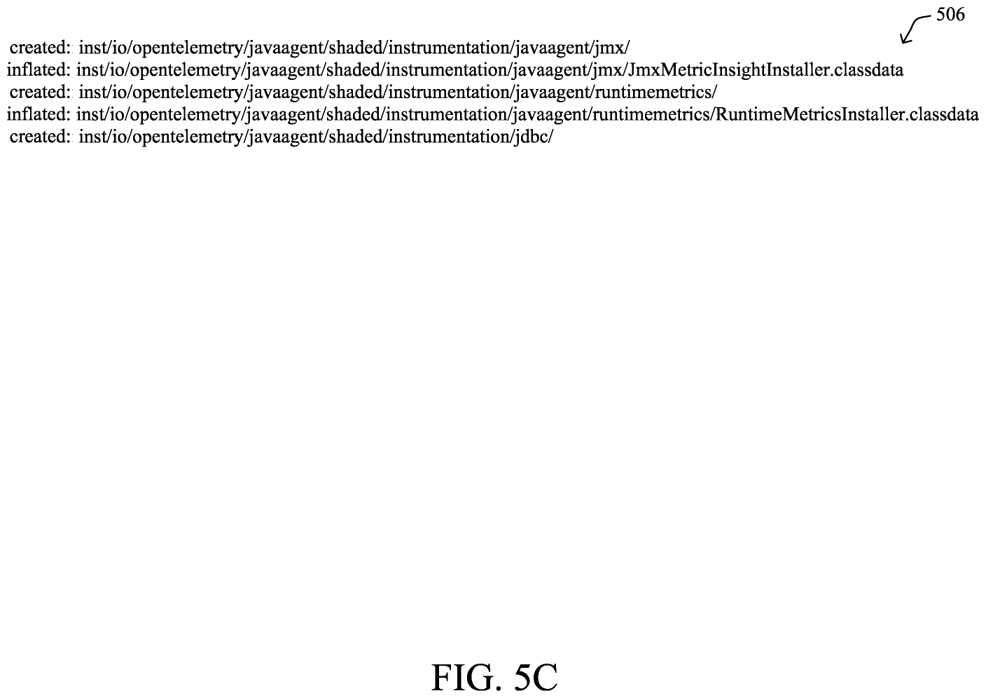

FIGS. 5A-5C illustrate examples of elements of the OSS Java agent extension architecture, in accordance with one or more implementations described herein. As previously mentioned, in the Java agent world, extensions are either identified via a folder (e.g., using the otel.javaagent.extensions property) or they are embedded into a Java agent “fat JAR”. Currently, embedding the extensions into a single JAR to reduce deployment complexity is the preferred method.

In the case of the OSS Java agent, each extension is a separate piece of functionality which is completely autonomous from any other extension. In fact, there is no way to load or unload extensions dynamically absent the presently disclosed generic extension wrapper approach. Dynamic extension loading or unloading is an extremely useful addition (e.g., for adding span, sampling extensions, etc.) given that restarting an application server is not a trivial task in terms of procedures and sign off from stakeholders.

An OSS Java agent may utilize an “@AutoService” annotation to include a class as an extension, thereby mapping it to a service provider file. When the OSS Java agent is extracted to a disk, these service provider files can be viewed. For example, FIG. 5A illustrates an example of an OTEL java agent extraction 502, whereby the service provider files are visible. FIG. 5B illustrates an example of contents 504 of an AgentListener file. When the AgentListener file is opened, the contents 504 reveal all the implementations for that extension type.

The extensions added to the service then need to be embedded into the OSS Java agent at the right location. In addition, the .class must be renamed so that it is loaded into the correct classloader. Generally, there are four main classloaders in the Java agent: Java virtual machine (JVM) boot loader, agent class loader, extension class loader, and the application class loader.

The JVM boot loader, being owned by the JVM, is shared among everything in the application. Consequently, there can be no conflicts with the JVM boot loader. The OSS Java agent shades (e.g., changes package names) to avoid such conflicts.

The application class loader is also owned by the JVM and, furthermore, by the application itself. Consequently, there can be no conflicts. In this case this loader mainly loads the agent (e.g., invoked by javaagent switch) which launches and quickly moves to the agent class loader.

The agent class loader may be the OSS Java agent's own isolated class loader. For example, the agent class loader may be specific to the OSS Java agent loader.

The extension class loader is for extensions. It may be possible to isolate them as well, with their parent being the agent class loader. In all cases, from the OSS Java agent out of the box it appears that the extension class loader is the agent class loader. If open-source libraries are being used in an extension, then its own loader would likely be required as other extensions may have conflicting libraries being used.

All of these extensions are utilizing a shared class loader (e.g., Extension Class Loader). Therefore, there conflicts will exist in the use of third-party libraries outside of the OSS Java agent (e.g., an extension could not have its own version of log4j and would have to use the OSS Java Agent version of build its own custom class loader).

FIG. 5C illustrates an example of class loading instructions 506 for extensions. Specifically, the class obfuscation for the extensions is illustrated in class loading instructions 506. Here, two implementations of the AgentListener to be loaded have the “.classdata” suffix. This operates as a special “tag” that instructs the agent class loader where this class is allowed to be loaded.

With respect to extension utility classes, or even sharing classes between extension(s) that have been created, it may be handled accordingly. Once loaded, an extension can refer to utility classes. However, these classes must be bundled into the OSS Java agent JAR and they also must be tagged with “.classdata”. Consequently, they will not be specified in the provider files, but referred to by an extension and then loaded by the OSS Java agent. These utilities also are shared among all extensions; thus, naming is important to avoid conflicts. This extension mechanism facilitates the application of extensions to the agent or the collector and is built on top of the Java Service Loader architecture.

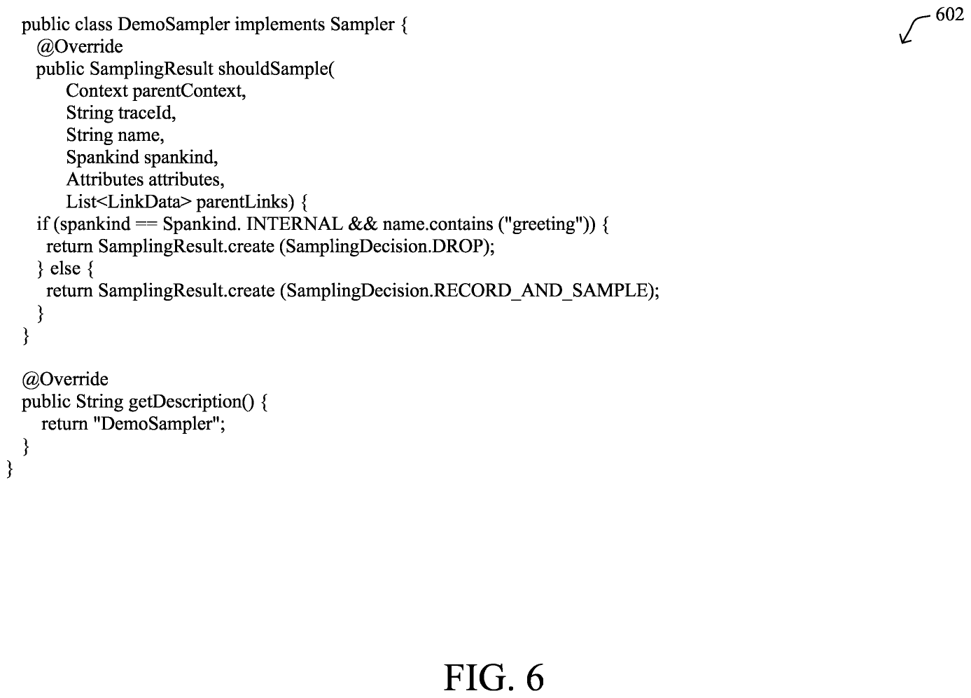

Conventionally, extensions are configured to simply tweak agent behavior during the course of an agent's lifecycle. Example extensions such as IDGenertor, TextMapPropagator, Sampler, SpanProcessor, SpanExporter, and so on are very small pivots in the operation of the OSS Java agent to give additional customization and control to developers for simple things like changing sampling or processing/tagging spans. FIG. 6 illustrates an example of custom sampler extension 602 which may be utilized with respect to the OSS Java agent. There are other extensions which allow complete control and the ability to launch additional modules which can take on any type of functionality. These are the extension interfaces which may be implemented utilizing the extension wrappers. These extension interfaces may have the ability to add custom capabilities outside of the OSS Java agent lifecycle and control. The AgentListener and AgentExtension plugin interfaces (e.g., extensions) may be utilized for this purpose. These may be referred to as “agent extensions.”

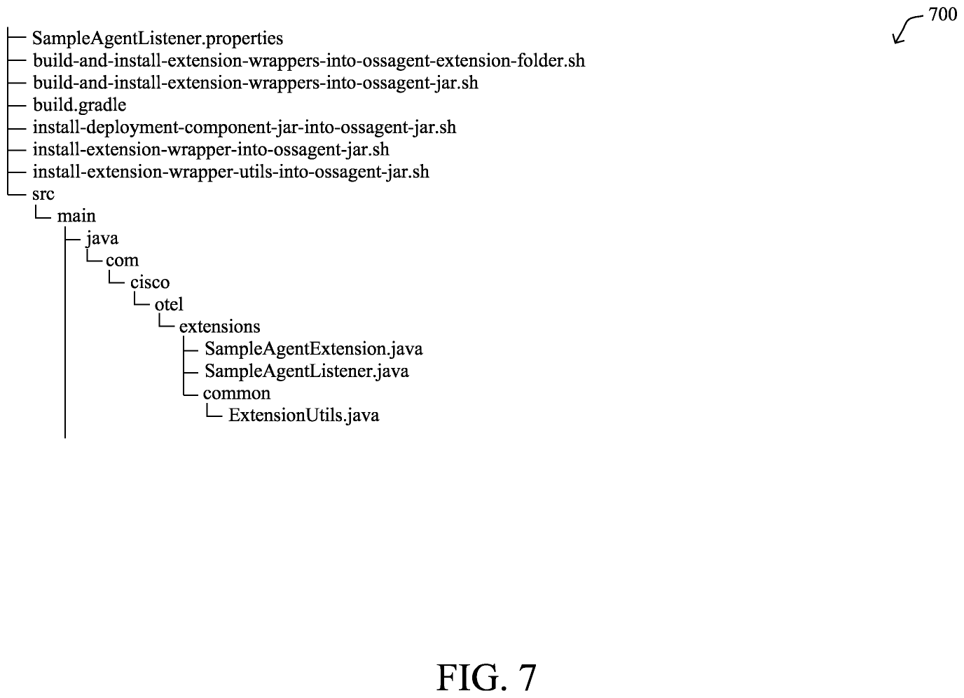

FIG. 7 Illustrates an example of a toolkit 700 for building and deploying agent extensions into the OSS Java agent, in accordance with one or more implementations described herein. Toolkit 700 may provide two options for building and deploying these extensions. Namely, a first option to embed into the OSS Java agent JAR and a second option to launch the extensions from a folder, as will be covered in greater detail below.

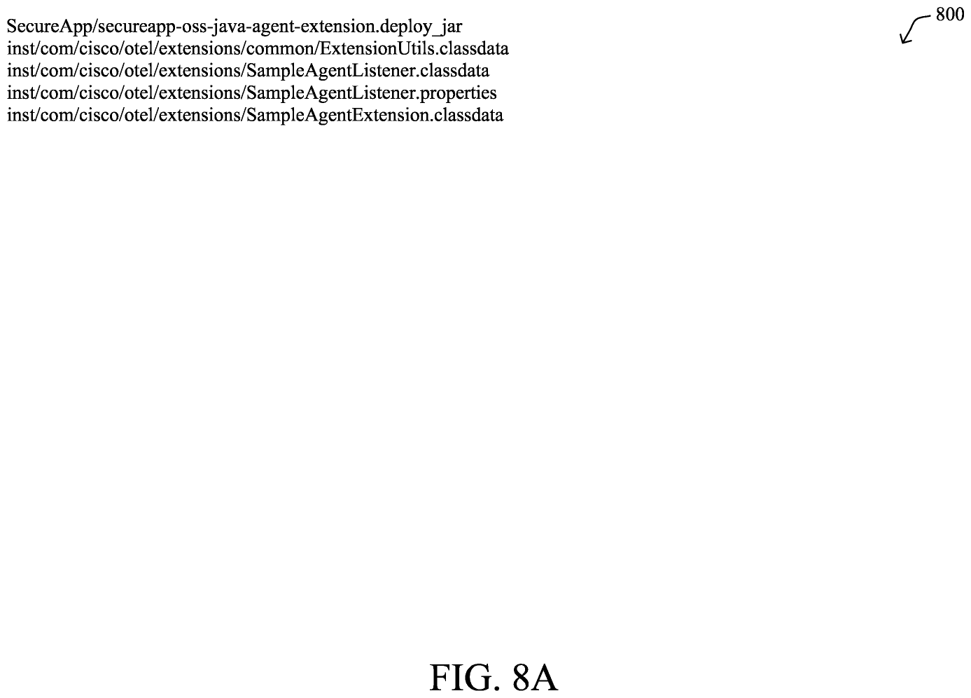

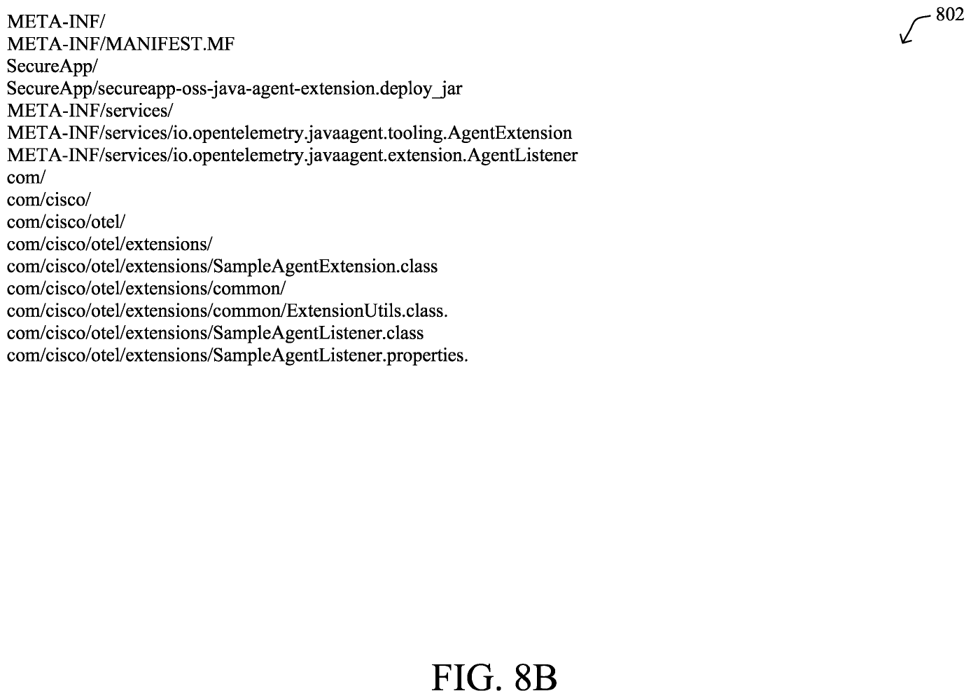

FIGS. 8A-8B illustrate examples of agent modified JARs for the toolkit building and deployment options for agent extensions, in accordance with one or more implementations described herein. As previously mentioned, the toolkit for building and deploying agent extensions into the agent provides two options for accomplishing the building and deployment.

The first option is embedding it into the OSS Java agent JAR (e.g., build-and-install-extension-wrappers-into-ossagent-jar.sh). The procedure for this may include downloading the OSS Java agent JAR (e.g., from Github, such as opentelemtry-agent.jar). Then, the deployment implementation distribution jar may be integrated into the OSS Java agent JAR. The deployment implementation distribution JAR may include the functionality to extend the OSS Java agent (e.g., for example Secure Application). The procedure may then include building the extension wrappers. The extension wrappers may include SampleAgentListener and/or SampleAgentExtension.

The procedure may include building the common utils code used by wrappers (e.g., ExtensionUtils). The procedure may include the integration of the common utils classes. This integration may be effectuated by converting .class files to .classdata files and integrating those files into the OSS Java agent JAR. In addition, the procedure may include integrating extension wrapper classes by converting .class files to .classdata files and integrating those files into the OSS Java agent JAR.

The procedure may include downloading the service provider files for AgentListener and AgentExtension interfaces used by the OSS Java agent JAR. In addition, each wrapper implementation may have its own *.properties file which provides the information for the wrapper implementation to perform its role in launching the deployment implementation. The service provider files may be modified to add the wrapper class names to be loaded by the agent Service Loader, and may be updated in the OSS Java agent Jar. The OSS Java agent modified JAR may be modified to contain these files and META-INF/services/io.opentelementry.javaagent.tooling.AgentExtension and META-INF/services/io.opentelementry.javaagent.extension.AgentListener provider files may be modified to support the extension wrappers, as illustrated in first option OSS Java agent modified JAR 800 in FIG. 8A.

The second option is launching the extensions from a folder such as by using the dotel.javaagent.extensions=folder/jar property (e.g., build-and-install-extension-wrappersinto-ossagent-extension-folder.sh). The procedure for this may include executing the procedure of the first option. Additionally, the procedure for the second option may include copying the extension to a working deployment folder (e.g., an inst folder) and/or copying the extension wrapper and extension util classes into the folder. Then, the .classes may be renamed back to .class from .classdata and/or an extension JAR (e.g., opentelemetry-javaagent-extensions.jar) may be created. The JAR may be placed into a folder and the Dotel.javaagent.extensions property may be set to point to it upon OSS Java agent startup. The second option OSS Java agent modified JAR 802 is illustrated in FIG. 8B.

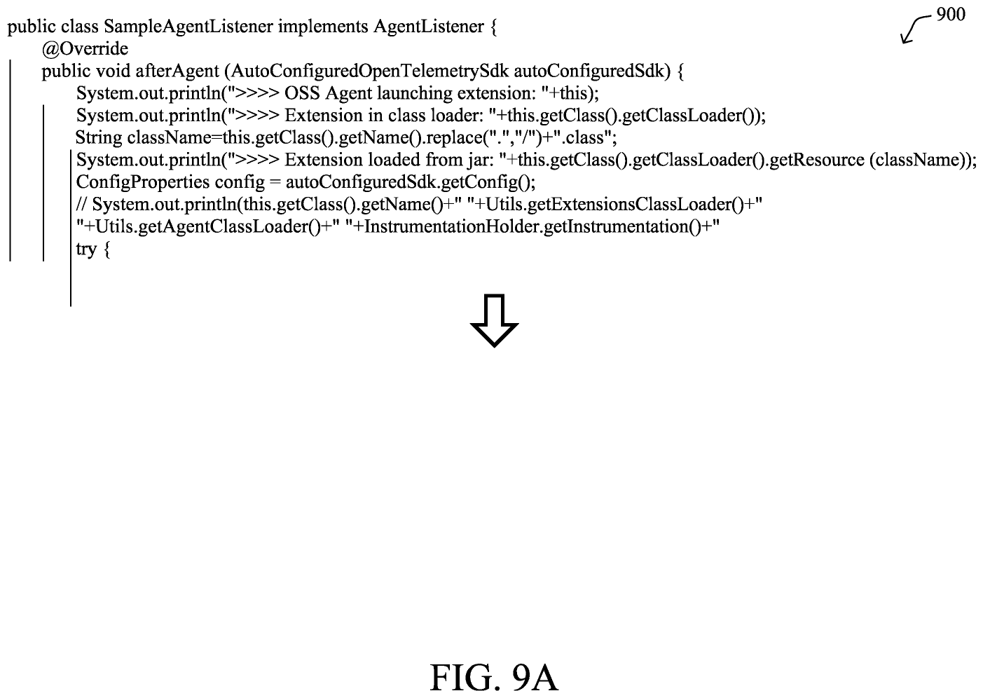

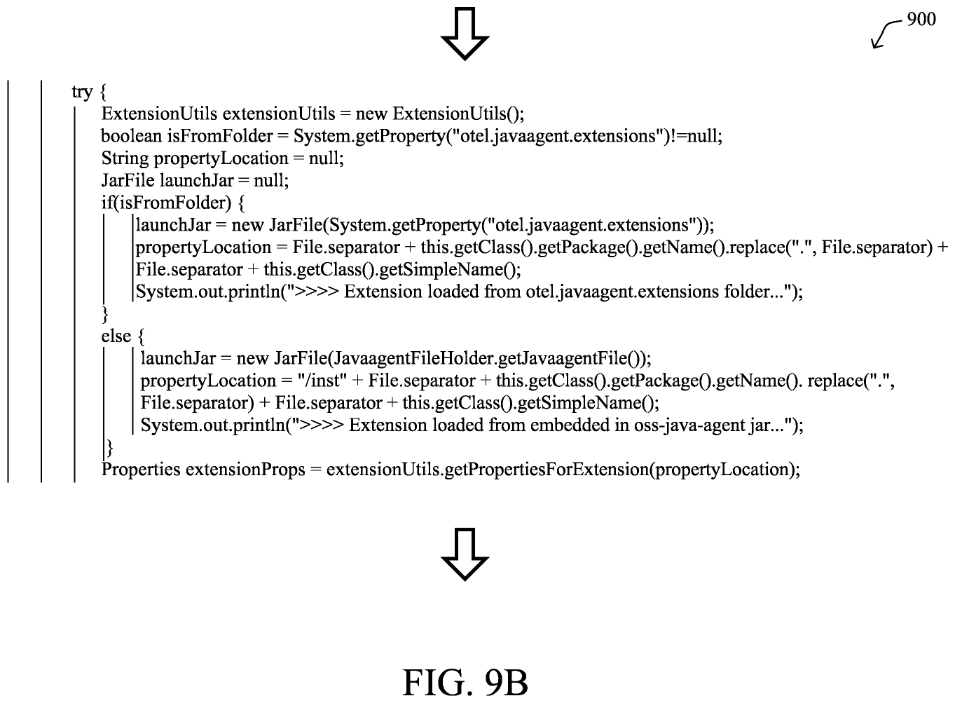

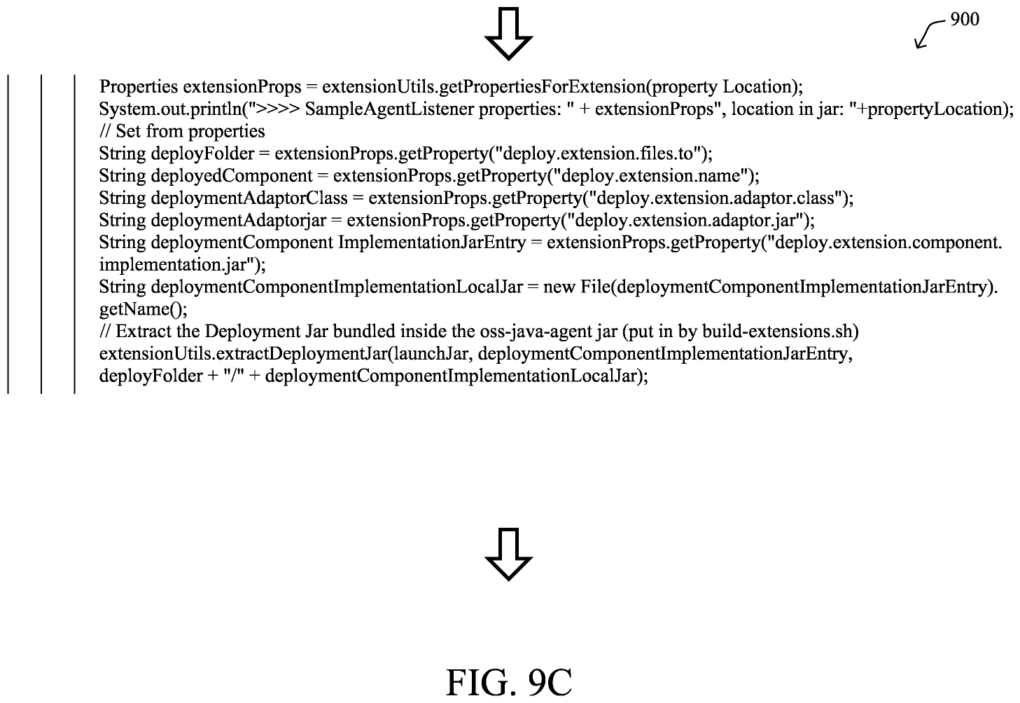

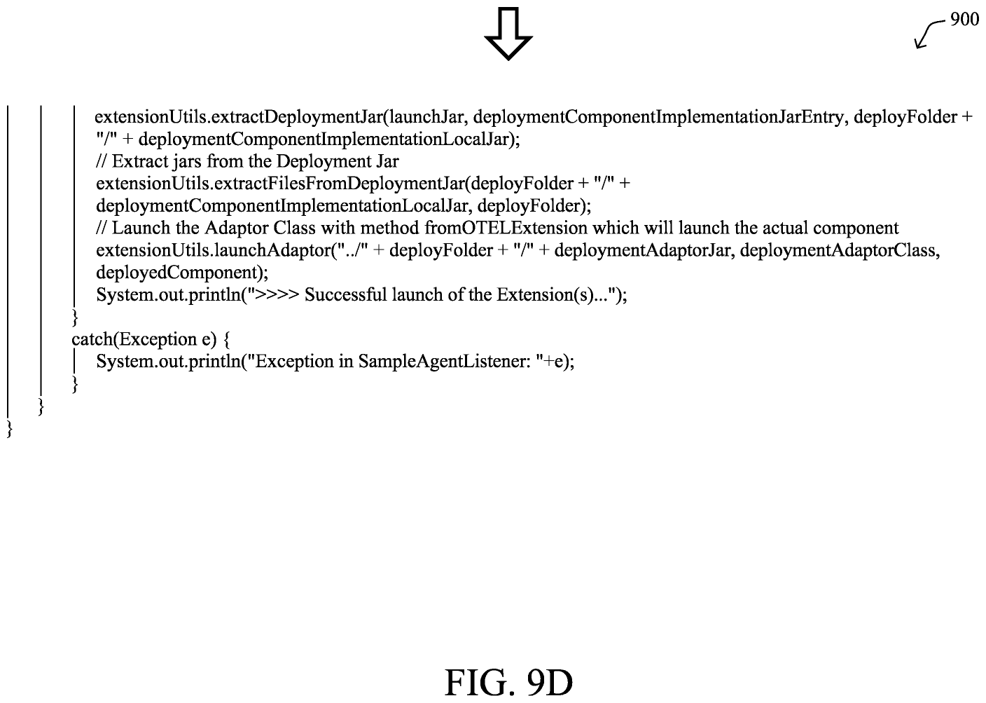

FIGS. 9A-9D illustrate an example of extension wrapper execution while running the OSS Java agent JAR, in accordance with one or more implementations described herein. Once the OSS Java agent JAR is launched, the OSS Java agent (in premain) may search for and/or identify implementations of the extension wrappers present in the service provider files. For example, the OSS Java agent may search for the AgentExtension and/or AgentListener implementations within the service provider files.

Extension wrapper implementation 900 is illustrated in terms of a “SecureApp” (e.g., a security utility that embeds security into the application runtime such as Secure Application). However, it should be appreciated that implementations are not so limited, and that other applications, extensions, and agents are possible as well. Within the SecureApp implementation the AgentListener is being utilized and thus will be identified.

When an implementation is found for one or more of the extension wrappers, the .classdata file will be loaded from the OSS Java agent JAR as a .class into the extensions classloader. For AgentExtension implementations, the extend method will be called and/or for AgentListener implementations the afterAgent method will be called. At this point, either of these methods is free to implement whatever it is so configured to do. In various implementations, these methods may be configured to block both the OSS Java agent JAR (e.g., premain method) as well as the application until completed.

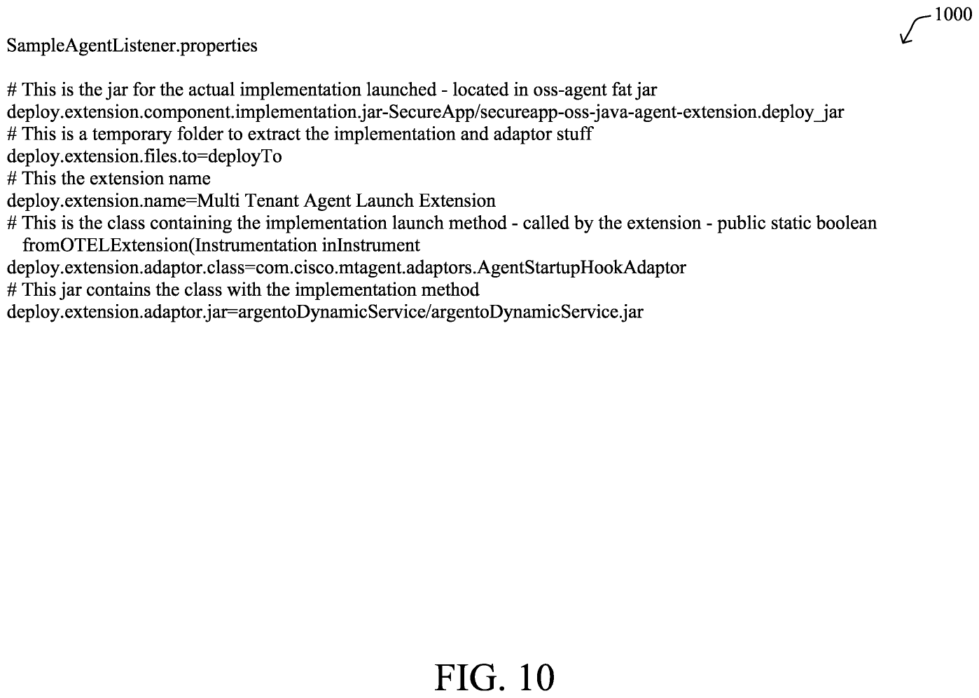

Extension wrapper implementation 900 demonstrates where the extension wrapper functionality is implemented with a specific focus on the SampleAgentListener wrapper implementation. The extension wrapper extracts and loads the SampleAgentListener property file from the OSS Java agent JAR. Utilizing the SampleAgentListener properties 1000 of FIG. 10, the extension wrapper will determine how to launch the implementation.

This determination may be made by extracting the component implementation JAR (e.g., defined by deploy.extension.component.implementation.jar) from the OSS Java agent JAR to a local folder (e.g., defined by deploy.extension.jars). Then all of the files from the component implementation JAR may be extracted into the local folder. Add adaptor jar (e.g., defined by deploy.extension.adaptor.jar) will be loaded into the application classpath. Then, the adapter class containing the launch method (e.g., defined by deploy.extension.adaptor.class) will be loaded. The static method “fromOTELExtension” will be called passing the OSS Java agent instrumentation handle so that the “component implementation” can utilize it. At this point, after that method returns, the wrapper is done, and the component implementation will perform its functionality.

The extension wrapper may be reusable as a packaging and launching mechanism. For instance, there may be no additional coding required to launch a variety of custom implementations. Instead, an extension wrapper may be repurposed to launch a new custom implementation through scripting, such as by creating a new properties file and changing names such that it is directed to the new custom implementations. Further, a developer may not need AutoService knowledge to navigate service loaders or complicated Gradle scripts with many plugins, nor do they need to understand the underlying extension complexity or architecture. Furthermore, the wrapper and wrapper utils are the only classes which run in the extension class loader. While the extension classloader may be ripe with conflict, it appears that extensions are to use OSS Java agent libraries. This means potential version and class loading conflicts if developers want to use their own third-party libraries.

With the component implementation (e.g., in one example the Multi-Tenant agent with no code changes) and a production utility (e.g., in one example, SecureApplication with no code changes) the Multi-Tenant agent guarantees that all of the component implementation classes will be isolated from the OSS Java agent class loaders. Therefore, no interfaces are needed for the component implementation, instead one method is needed to launch it, from OTELExtension.

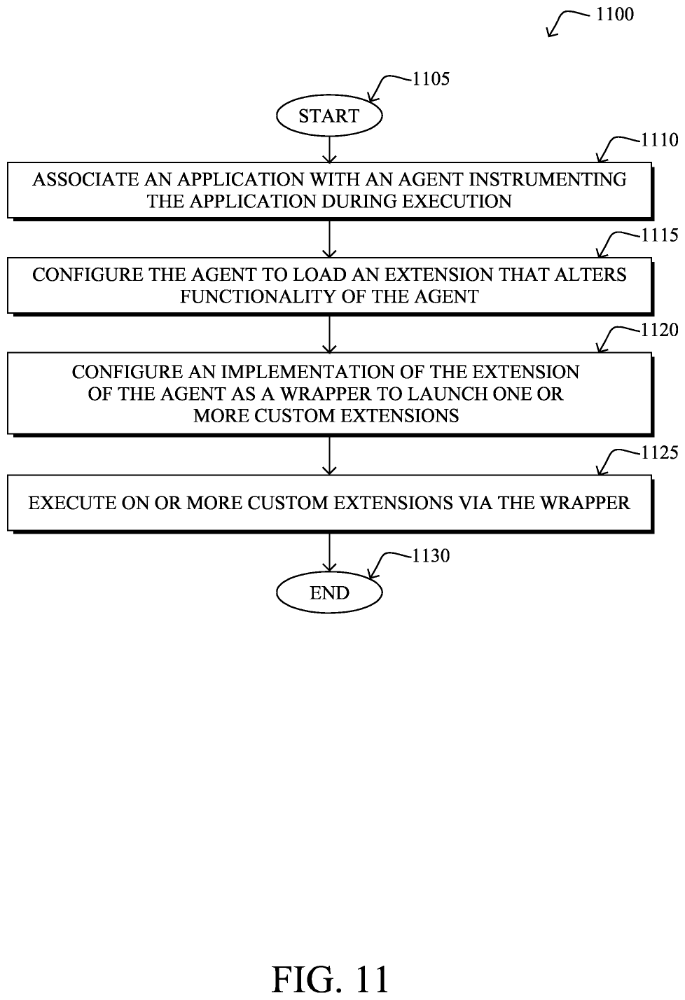

FIG. 11 illustrates an example simplified procedure for launching custom extension by extension wrappers, in accordance with one or more implementations described herein. For example, a non-generic, specifically configured device (e.g., device 200) may perform procedure 1100 by executing stored instructions (e.g., custom extension process 248). Procedure 1100 may start at step 1105, and continues to step 1110, where, as described in greater detail above, an application is associated with an agent that illustratively generates OpenTelemetry data (or other metrics or data) by instrumenting the application during execution.

At step 1115, as detailed above, the agent may be configured to load an extension that alters the functionality of the agent. The extension of the agent may be an AgentListener interface implementation. The AgentListener interface implementation may be configured to launch the one or more custom extensions of the agent responsive to an afterAgent method being called.

In various implementations, the extension of the agent may be an AgentExtension interface implementation. The AgentExtension interface implementation may be configured to launch the one or more custom extensions of the agent responsive to an extend method being called.

At step 1120, an implementation of the extension of the agent may be configured as a wrapper to launch one or more custom extensions. Launching the one or more custom extensions may include integrating additional functionality to the agent from outside of the implementation of the extension. This may include embedding logic from the one or more custom extensions in a jar of the agent.

In various implementations, the one or more custom extensions may be launched from a designated folder using a specified property during a bootstrap phase of the agent. The implementation of the extension of the agent may be configured to block execution of the agent until a launch of the one or more custom extensions is completed.

At step 1125, as noted above, the one or more custom extensions may be executed via the wrapper. This may include dynamically loading or unloading the one or more custom extensions without rebooting an application server executing the agent.

The one or more custom extensions may operate in an environment isolated from agent class loaders of the agent. The wrapper may be configured to be expanded to launch an additional custom extension responsive to creation of a new properties file for the additional custom extension.

Procedure 1100 then ends at step 1130.

It should be noted that while certain steps within procedure 1100 may be optional as described above, the steps shown in FIG. 11 are merely examples for illustration, and certain other steps may be included or excluded as desired. Further, while a particular order of the steps is shown, this ordering is merely illustrative, and any suitable arrangement of the steps may be utilized without departing from the scope of the implementations herein.

The techniques described herein, therefore, facilitate launching of custom extensions by extension wrappers. By using generic extension wrappers, developers are no longer limited to launching functionality that is tied to a specific interface of an agent. Instead, the techniques facilitate the ability to launch generic modules which extend or complement the value of the agent itself. Moreover, the extension wrappers are reusable and expandable to a variety of different custom implementations simply by creating new properties files. This architecture and interface to the Java agent automates and simplifies the ability to embed extensions to the Agent that can add custom capabilities outside of the Java Agent lifecycle and control.

Various types of functional extensions are envisioned as being implemented through these techniques. For example, an application security extension may be utilized. This could include Open Telemetry Security Extensions, which would involve moving Secure Application functionality to use OT Eventing, Key-Value Pair Attributes, Exception capturing, and setting Span Status. Another example may include a Security Circuit Breaker Extension, which would involve automatically setting circuit breaker technology into OT Span Exits. Yet another example may include a Debugging Snapshot Extension focused on debugging and on Key Value Pairs, would be on demand, and would potentially pass context between spans. Another example may include an Exception Logging Extension, which would include advanced logging of Exceptions using a central piece of instrumentation to capture Performance related Exceptions from a single instrumentation point without requiring method instrumentation.

In another example, an extension may be an Optimization and “Self Healing” Extension, which could include optimizing things in the Java Runtime such as DNS lookups, Fault Tolerant Thread Pools, Reflection Optimizations, etc. A Custom Span Status Extension may be utilized where every Span can have a status and even a custom status, which can be set based on Performance or Security seen during the Span's activity. In another example, an extension may be an OSS Agent Optimization and Monitoring Extension for optimizing (e.g., memory, cpu, etc.) and monitoring capabilities for troubleshooting the OSS Agent activities. In addition, an Application Context Aware Firewall Extension may be utilized, which includes an outbound firewall (with no hardware required) where decisions are made based on what module, code trace, protocol, etc. is behind the call.

In various implementations, a Reflection Runtime Protection and Auditing Extension and/or Dynamic Socket QOS Setting Extension may be implemented. Further, a DNS Caching Extension may be implemented which “transforms” the core Java DNS caching to use a “hard cache” (on disk) which greatly improves startup times, and also includes a function which behind the scenes does lookups “out of band-none blocking” to correct the cache on the fly and on the security side. Furthermore, a Java Module Management Extension may be implemented which monitors a running Java 9+ application and “record” the JMPS access requests while preventing any failures, automatically applies the “recording” to a highly flexible, powerful “scripting language,” and allows the application stakeholder to run their newly migrated applications in a “Safe Mode” in production while flagging potential JMPS issues.

In addition, the extensions may include a Microservice Manager and Optimizer that provides management functions and optimization for Microservice environment focusing primarily on the use of Reflection in the Java Runtime and controlling the Java Runtime Optimization techniques and facilitates monitoring of all REST endpoints from a single instrumentation point which optimizes the amount of instrumentation required. Further, the extension may be a Span Info Extension that places things like GEO location information into the Span so that the origination of the Span is easily identified. Moreover, the extension may be a Span Troubleshooting Extension, which records all Spans in the OTEL system including those sampled out and provides the ability to record call stacks for the Spans, etc.

According to the implementations herein, an illustrative method herein may comprise: associating, by a device, an application with an agent that instruments the application during execution; configuring, by the device, the agent to load an extension that alters functionality of the agent; configuring, by the device, an implementation of the extension of the agent as a wrapper to launch one or more custom extensions; and executing, by the device, the one or more custom extensions via the wrapper.

In one implementation, the agent generates OpenTelemetry data while instrumenting the application. In one implementation, the extension of the agent is an AgentListener interface implementation. In one implementation, the AgentListener interface implementation is configured to launch the one or more custom extensions of the agent responsive to an afterAgent method being called. In one implementation, the extension of the agent is an AgentExtension interface implementation. In one implementation, the AgentExtension interface implementation is configured to launch the one or more custom extensions of the agent responsive to an extend method being called. In one implementation, launching the one or more custom extensions includes integrating additional functionality to the agent from outside of the implementation of the extension.

In one implementation, the method further comprises dynamically loading or unloading the one or more custom extensions without rebooting an application server executing the agent. In one implementation, the one or more custom extensions are launched from a designated folder using a specified property during a bootstrap phase of the agent. In one implementation, the implementation of the extension of the agent is configured to block execution of the agent until a launch of the one or more custom extensions is completed. In one implementation, the wrapper is configured to be expanded to launch an additional custom extension responsive to creation of a new properties file for the additional custom extension.

In one implementation, the one or more custom extensions operate in an environment isolated from agent class loaders of the agent. In one implementation, the method further comprises embedding logic from the one or more custom extensions in a jar of the agent.

According to the implementations herein, an illustrative tangible, non-transitory, computer-readable medium having computer-executable instructions stored thereon that, when executed by a processor on a computer, cause the computer to perform a method comprising: associating an application with an agent that instruments the application during execution; configuring the agent to load an extension that alters functionality of the agent; configuring an implementation of the extension of the agent as a wrapper to launch one or more custom extensions; and executing the one or more custom extensions via the wrapper.

According to the implementations herein, an illustrative apparatus comprising: one or more network interfaces to communicate with a network; a processor coupled to the one or more network interfaces and configured to execute one or more processes; and a memory configured to store a process that is executable by the processor, the process, when executed, configured to associate an application with an agent that instruments the application during execution; configure the agent to load an extension that alters functionality of the agent; configure an implementation of the extension of the agent as a wrapper to launch one or more custom extensions; and execute the one or more custom extensions via the wrapper.

While there have been shown and described illustrative implementations herein that facilitate launching of custom extensions by extension wrappers, it is to be understood that various other adaptations and modifications may be made within the spirit and scope of the implementations herein. For example, while certain implementations herein are described herein with respect to using the techniques herein for certain purposes, the techniques herein may be applicable to any number of other use cases, as well. In addition, while certain types of extensions are discussed herein, the techniques herein may be used in conjunction with any extension, whether for OpenTelemetry or other protocols.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true spirit and scope of the implementations herein.

What is claimed is:

1. A method, comprising:
associating, by a device, an application with an agent that instruments the application during execution;
configuring, by the device, the agent to load an extension that alters functionality of the agent;
configuring, by the device, an implementation of the extension of the agent as a wrapper to launch one or more custom extensions; and
executing, by the device, the one or more custom extensions via the wrapper.

2. The method of claim 1, wherein the agent generates OpenTelemetry data while instrumenting the application.

3. The method of claim 1, wherein the extension of the agent is an AgentListener interface implementation.

4. The method of claim 3, wherein the AgentListener interface implementation is configured to launch the one or more custom extensions of the agent responsive to an afterAgent method being called.

5. The method of claim 1, wherein the extension of the agent is an AgentExtension interface implementation.

6. The method of claim 5, wherein the AgentExtension interface implementation is configured to launch the one or more custom extensions of the agent responsive to an extend method being called.

7. The method of claim 1, wherein launching the one or more custom extensions includes integrating additional functionality to the agent from outside of the implementation of the extension.

8. The method of claim 1, further comprising:
dynamically loading or unloading the one or more custom extensions without rebooting an application server executing the agent.

9. The method of claim 1, wherein the one or more custom extensions are launched from a designated folder using a specified property during a bootstrap phase of the agent.

10. The method of claim 1, wherein the implementation of the extension of the agent is configured to block execution of the agent until a launch of the one or more custom extensions is completed.

11. The method of claim 1, wherein the wrapper is configured to be expanded to launch an additional custom extension responsive to creation of a new properties file for the additional custom extension.

12. The method of claim 1, wherein the one or more custom extensions operate in an environment isolated from agent class loaders of the agent.

13. The method of claim 1, further comprising:
embedding logic from the one or more custom extensions in a jar of the agent.

14. A tangible, non-transitory, computer-readable medium having computer-executable instructions stored thereon that, when executed by a processor on a computer, cause the computer to perform a method comprising:
associating an application with an agent that instruments the application during execution;
configuring the agent to load an extension that alters functionality of the agent;
configuring an implementation of the extension of the agent as a wrapper to launch one or more custom extensions; and
executing the one or more custom extensions via the wrapper.

15. The tangible, non-transitory, computer-readable medium as in claim 14, wherein the extension of the agent includes an AgentListener interface implementation and wherein the AgentListener interface implementation is configured to launch the one or more custom extensions responsive to an afterAgent method being called.

16. The tangible, non-transitory, computer-readable medium as in claim 14, wherein the extension of the agent includes an AgentListener interface implementation and wherein the AgentListener interface implementation is configured to launch the one or more custom extensions responsive to an afterAgent method being called.

17. The tangible, non-transitory, computer-readable medium as in claim 14, wherein the extension of the agent includes an AgentExtension interface implementation and wherein the AgentExtension interface implementation is configured to launch the one or more custom extensions responsive to an extend method being called.

18. The tangible, non-transitory, computer-readable medium as in claim 14, wherein launching the one or more custom extensions includes integrating additional functionality to the agent from outside of the implementation of the extension.

19. The tangible, non-transitory, computer-readable medium as in claim 14, the method further comprising:
dynamically loading or unloading the one or more custom extensions without rebooting an application server executing the agent.

20. An apparatus, comprising:
one or more network interfaces to communicate with a network;
a processor coupled to the one or more network interfaces and configured to execute one or more processes; and
a memory configured to store a process that is executable by the processor, the process, when executed, configured to:
associate an application with an agent that instruments the application during execution;
configure the agent to load an extension that alters functionality of the agent;
configure an implementation of the extension of the agent as a wrapper to launch one or more custom extensions; and
execute the one or more custom extensions via the wrapper.
